(19) United States
(12) Patent Application Publication
(10) Pub. No.: US 2004/0158638 A1
(43) Pub. Date: Aug. 12, 2004

(54) Providing static and dynamic event data

(76) Inventors: Jay R. St. Peters, Atlanta, IN (US); Gerald P. Hunt, Fishers, IN (US)

Correspondence Address: FISH & RICHARDSON P.C., 1425 K STREET, N.W., 11TH FLOOR, WASHINGTON, DC, 20005-3500, US

(21) Appl. No.: 10/360,570

(22) Filed: Feb. 6, 2003

(51) Int. Cl. G06F 15/16; H04L 9/00

(52) U.S. Cl. 709/227; 713/164

(57) ABSTRACT

Techniques for providing static and dynamic event data are disclosed. In one implementation, a mobile user interface device has the capability to determine whether static event data has been received, determine whether an event wireless network has been detected, establish a wireless network session if an event wireless network has been detected, and determine whether dynamic event data has been received in a wireless network message. When static and/or dynamic event data have been received, a user interface may be generated to present at least some of the static event data and at least some of the dynamic event data. A wireless network may have the capability to determine whether a wireless network session is authorized and to determine the level of service required for the session.

### TECHNICAL FIELD

This description relates to providing data, and more particularly, to providing static and dynamic event data.

### BACKGROUND

When spectators attend sporting events, programs containing information regarding the participating teams and players, and possibly the event site itself, are typically offered for sale. By purchasing and reviewing a program, a spectator may gain more insight into the teams and players and, hence, enhance his event experience.

Unfortunately, because these programs are printed, they must be produced in advance and, thus, do not have the latest information regarding the event. Additionally, the average spectator does not, even after reading the program, have a keen knowledge of the teams and players. Furthermore, the spectator's knowledge of incidents during the event may be less than optimal due to his view being partially obstructed and/or distant and/or his lack of knowledge regarding the teams and players.

### SUMMARY

Techniques are provided for providing static and dynamic event data. In one general aspect, providing static and dynamic event data includes determining, at a mobile user interface device, whether static event data has been received, determining, at the mobile user interface device, whether an event wireless network has been detected, establishing, at the mobile user interface device, a wireless network session if an event wireless network has been detected, and determining, at the mobile user interface device, whether dynamic event data has been received in a wireless network message. When static and/or dynamic event data have been received, a user interface may be generated to present at least some of the static event data and at least some of the dynamic event data. The operations may be performed using any appropriate type of mobile user interface device. Moreover, the operations may be performed by instructions encoded in media.

Implementations may include one or more of the following features. For example, providing static and dynamic event data may include generating, at the mobile user interface device, a user interface to present at least some of the static event data if static event data has been received. Additionally, providing static and dynamic event data may include determining, at the mobile user interface device, whether dynamic event data has been received in a wireless network message, determining, if dynamic event data has been received, whether the user interface should be updated with the dynamic event data, and updating the user interface with the dynamic event data if the user interface should be updated with the dynamic event data. The static event data may include pre-event statistics regarding an event participant, the user interface may include a graphical user interface, and the dynamic event data may include event statistics regarding an event participant. Providing static and dynamic event data may also include determining, at the mobile user interface device, whether a signal indicating a request to alter the user interface has been received and updating the user interface if such a signal has been received. Providing static and dynamic event data may additionally include determining, at the mobile user interface device, whether a signal indicating a request for dynamic event data has been received and generating a wireless network message requesting dynamic event data if such a message has been received. Establishing a wireless network session may include generating a wireless network message to register the mobile user interface device with a predefined event identifier.

In another general aspect, providing static and dynamic event data includes detecting, at a wireless network, establishment of a wireless network session for an event, determining whether dynamic event data should be sent to a mobile user interface device if initiation of a wireless network session for an event is detected, and generating a wireless network message containing dynamic event data if dynamic event data should be sent to a mobile user interface device.

Implementations may include one or more of the following features. For example, providing static and dynamic event data may include determining whether a wireless network message requesting dynamic event data has been received from a mobile user interface device and generating a wireless network message containing dynamic event data if a wireless network message requesting dynamic event data has been received from a mobile user interface device. Additionally, providing static and dynamic event data may include determining whether static event data should be sent to a mobile user interface device and generating a wireless network message containing static event data if static event data should be sent to a mobile user interface device. Furthermore, providing static and dynamic event data may include determining whether the wireless network session is authorized and determining the level of service required for the session.

In a particular general aspect, a system for providing static and dynamic event data include a mobile user interface device and a wireless network. The mobile user interface device is operable to determine whether static event data has been received, generate a graphical user interface to present at least some of the static event data if static event data has been received, determine whether an event wireless network has been detected, establish a wireless network session if an event wireless network has been detected, determine whether dynamic event data has been received in a wireless network message, determine, if dynamic event data has been received, whether the user interface should be updated with the dynamic event data, update the user interface with the dynamic event data if the user interface should be updated with the dynamic event data, determine whether a signal indicating a request to alter the user interface has been received, update the user interface if such a signal has been received, determine whether a signal indicating a request for dynamic event data has been received, and generate a wireless network message requesting dynamic event data if such a message has been received. The wireless network is operable to detect establishment of the wireless network session, determine whether the wireless network session is authorized, establish the wireless network session with the mobile user interface device if the wireless network session is authorized, determine whether dynamic event data should be sent to the mobile user interface device if the wireless network session is established, generate a wireless network message containing dynamic event data if dynamic event data should be sent to the mobile user interface device, determine whether the wireless network message requesting dynamic event data has been received from the mobile user interface device, and generate a wireless network message containing dynamic event data if the wireless network message requesting dynamic event data has been received from the mobile user interface device.

The details of one or more implementations of the invention are set forth in the accompanying drawings and the description below. Other features of the invention will be apparent from the description and drawings, and from the claims.

### DESCRIPTION OF DRAWINGS

FIG. 1 is a block diagram illustrating a system for providing static and dynamic event data.

FIG. 2 is a block diagram illustrating a mobile user interface device for providing static and dynamic event data.

FIG. 3 is a flowchart illustrating a method for providing static and dynamic event data.

FIG. 4 is a flowchart illustrating a method for providing static and dynamic event data.

FIG. 5 illustrates a user interface.

Like reference symbols in the various drawings indicate like elements.

### DETAILED DESCRIPTION

Providing static and dynamic event data includes conveying event-related data to a mobile user interface device. One application is in the field of sporting events. Thus, a spectator may receive historical as well as current data regarding teams and players participating in the sporting event. Providing static and dynamic data, however, is not limited to sporting events and may include conveying event-related data to a mobile user interface device at any type of event.

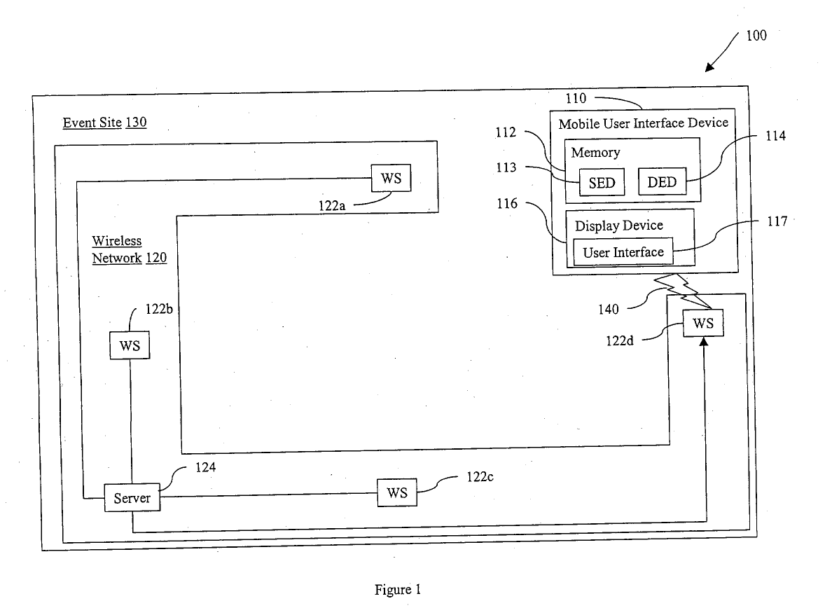

FIG. 1 illustrates a system 100 for providing static and dynamic event data. In general, system 100 includes a mobile user interface device 110 and a wireless network 120, located at an event site 130. In operation, mobile user interface device 110 receives static data regarding the event, which is data that typically does not change during the event, such as, for example, biographical data about event participants, data about the event site 130, and data about the history of the event. Additionally, mobile user interface device 110 receives dynamic data regarding the event, which is data that is generated during the event, such as, for example, statistics and status of event participants. Wireless network 120 is responsible for sending static and/or dynamic event data to mobile user interface device 110. Mobile user interface device 110 is also responsible for presenting the static and dynamic event data to a user of the interface device.

In more detail, mobile user interface device 110 includes memory 112 and a display device 116. Memory 112 may be random access memory (RAM), read-only memory (ROM), a flash card, compact-disk read-only memory (CD-ROM), a PCMCIA card, registers, and/or any other appropriate type of volatile or non-volatile information storage apparatus. Memory 112 includes static event data 113 and dynamic event data 114. Static event data 113 and dynamic event data 114 may be text, audio, graphics, video, statistics, and/or any other appropriate type of information about an event. The data may be in any appropriate format for display, such as, for example, Extensible Markup Language (XML), HyperText Markup Language (HTML), Wireless Markup Language (WML), or iMode. Memory 112 may also store other data and/or instructions for mobile user interface device 110. In particular embodiments, memory 112 includes a Web-browser for generating a user interface to display the event data.

As mentioned previously, static event data 113 is data that typically does not change as the event progresses, and dynamic data 114 is data that typically does change as the event progresses. For example, a sporting-event participant's name, height, weight, and previous year's statistics do not change during an event and, hence, are static. By contrast, the participant's statistics during the event do change and, hence, are dynamic. Other examples of dynamic data include telemetry from an automobile, event-site weather conditions, a replay of a recent event incident, and play prediction. Static event data 113 may be stored on removable information storage devices, such as, for example, a CD-ROM, a smart card, a PCMCIA card, or a DVD, downloaded from wireless network 120, downloaded from a landline network, such as, for example, the Internet, or otherwise captured in memory 112. The data may be stored in either a compressed or uncompressed format. In particular implementations, the static event data may mimic a traditional souvenir sports program and may be acquired using data mining techniques to establish the needed fields and present the data. Dynamic event data 114, in turn, is downloaded from wireless network 120. The dynamic event data may or may not be distributed in real-time.

Display device 116 is responsible for displaying a user interface 117, which contains the static and/or dynamic event data. Display device 116 may be a cathode ray tube (CRT) display, a liquid crystal display (LCD), a projector, or any other appropriate type of device for displaying information. User interface 117 may be a text-based interface, a graphics based interface, an interactive interface, and/or an interface having any other appropriate format for presenting information. User interface 117 may be browser-based, custom-developed, or in some other format. In certain implementations, a high-density TV broadcast display may replace a browser-based technique.

Mobile user interface device 110 additionally includes devices for facilitating the manipulation and/or transfer of information. For example, mobile user interface device 110 may include a processor, such as, for example, an analog processor, a digital processor, a biological processor, an atomic processor, or any other appropriate type of apparatus for manipulating information in a logical manner, and a wireless communication interface, such as, for example, a wireless transceiver or any other appropriate type of apparatus for wirelessly sending and receiving information. Mobile user interface device 110 also may include any appropriate type of apparatus for allowing user input, such as, for example, a button, a keyboard, a track ball, a touch pad, with or without a stylus, a mouse, a light pen, or a microphone. If handwriting or voice commands are involved, mobile user interface device 110 may also include instructions or circuitry for recognizing handwriting or voice. In certain implementations, mobile user interface device 110 also includes an audio output apparatus, such as, for example, a speaker, a buzzer, or a bell. In particular implementations, mobile user interface device 110 may be a wirelessly-equipped personal digital assistant (PDA).

Mobile user interface device 110 is coupled to wireless network 120 by a link 140. Link 140 may be a radio frequency (RF) wireless link, such as, for example, a Bluetooth™ link or an IEEE 802.11 link, an infrared (IR) wireless link, a cellular or satellite link, or any other appropriate type of wireless path for transferring information. Data may be sent across link 140 according to any appropriate protocol, such as, for example, the Internet protocol (IP), and may be secured by RSA encryption or any other appropriate type of security protocol.

Wireless network 120 includes wireless stations 122 and a server 124. Wireless stations 122 are positioned around event site 130 to provide wireless communication with mobile user interface device 110. It should be noted that event site 130 may have any number of wireless stations 122. Wireless stations 122 send information to and receive information from mobile user interface device 110. Wireless stations 122 may include wireless transceivers that operate according to any appropriate protocol, such as, for example, Bluetooth™ or IEEE 802.11. Server 124 is responsible for distributing static and/or dynamic event data to wireless stations 122 for conveyance to mobile user interface device 110. The data may be received from any of a variety of sources, such as, for example, an official scorer's computer, a TV network computer, or a specialized analyst's computer. In particular implementations, server 124 and mobile user interface device 110 may enter into a client/server relation and may relate to each other using Web Service Description Language (WSDL), Simple Object Access Protocol (SOAP), or Universal Description, Discovery and Integration (UDDI). Server 124 may use push techniques, pull techniques, or any other appropriate technique to send data to mobile user interface device 110.

Wireless network 120 may also include other devices for facilitating the transfer of information to mobile user interface device 110. For example, wireless network 120 may include transceivers, switching centers, packet data servers, station controllers, and/or devices of any other appropriate type for receiving and transferring information.

In one mode of operation, mobile user interface device 110 receives static event data before or after arriving at an event. For example, the static event data may be downloaded over the Internet before traveling to the event, or removable media such as a smart card may be obtained and inserted at the event. Mobile user interface device 110 may generate a user interface to display the static event data. The interface device may also update the user interface, which many include generating another user interface. The user interface may be generated and/or updated automatically, in response to user commands, or otherwise. In certain embodiments, instructions for generating a user interface for the event data and/or accessing the wireless network may be acquired in the same manner as the static event data.

When at the event site itself, mobile user interface device 110 detects the presence of wireless network 120 and establishes a wireless network session with wireless network 120.

Detecting the wireless network may include detecting a wireless signal that contains a recognized identifier for the wireless network for the event. The recognized identifier may be included with the static event data. Establishing a wireless network session may entail registering the mobile user interface device, validating the mobile user interface device, negotiating channels, negotiating access times, determining service levels for the mobile user interface device, and/or any other appropriate functions for establishing a wireless network session. Also included with the static event data may be login or subscription information for accessing the event wireless network, for determining the service level for the mobile wireless unit, and/or for charging fees for wireless network services. Login or subscription information may include a wireless-network-assigned identifier, an identifier for interface device 100, a password, or any other appropriate registration and/or validation data.

After establishing a wireless network session, mobile user interface device 110 is able to receive dynamic event data from wireless network 120. As mentioned previously, the dynamic event data may be pushed to or pulled by mobile user interface device 110. Dynamic event data may include current analysis of the event, recent event data, replay data, overhead views of the event, and the like. If data is pushed to mobile user interface device 110, the device may determine whether the user wants the information to be displayed currently or whether the data may be desired later. If neither, the device may discard the data. After receiving desired dynamic data, the user interface may be updated with the data, which may include generating another user interface. Updating the user interface may, for example, include replacing some of the presented static event data with dynamic event data.

Mobile user interface device 110 may also detect signals indicating a request for dynamic event data. The signals may be generated in response to commands from a user, for example. Upon making such a detection, the mobile user interface device generates a wireless network message requesting dynamic event data. Wireless network 120 responds to the message by retrieving the data and generating and sending a wireless network message containing the data. Upon receiving the data, the mobile user interface device may update the user interface.

Additionally, the mobile user interface device may detect a signal indicating a request to alter the user interface. The user interface may be updated to display different static event data and/or dynamic event data.

System 100 has a variety of features. For example, because mobile user interface device 110 can provide static event data and dynamic event data to a user, more relevant data may be delivered to a spectator at an event, enhancing the spectator's experience. Furthermore, the system may provide less expensive publishing of data, which will aid in the distribution of more data. As another example, spectator interaction may be implemented to allow spectators to engage in actions such as requesting specific data, play-by-play data, and replays, and to thereby further enhance the spectator experience. As a further example, by providing varying levels of service, the system allows for billing differentiation between users. Note, however, that in some implementations a base level of service may be free.

System 100 may be used at a variety of events. For example, at automobile races, a mobile user interface device may receive and output the communications between pit crew and driver, automobile telemetry data, updated place standings, pit stop information, and/or any other appropriate data. At football and basketball events, a mobile user interface device may receive and output data on individual player statistics, plays, formations, teams, players to watch, and/or any other appropriate information. In certain implementations, a user may even be involved in an interactive play prediction technique. At Olympic events, a mobile user interface device may provide a schedule of events, a map of venues, weather forecasts, qualifying information, current medal count standings, and/or any other appropriate data. For golf events, a mobile user interface device may provide the current hole and score for each participant, participant statistics, replays of interesting shots, and/or any other appropriate data. For soccer events, a mobile user interface device may provide the current time, penalty time, players to watch, replays, player statistics, team statistics, and/or any other appropriate data. For baseball events, a mobile computing device may provide the current count, player statistics, pitching statistics, team statistics, and/or any other appropriate data.

In particular implementations, static event data may be downloaded from the wireless network. Furthermore, in some implementations, data from different event sites may be combined and sent to an event site for download to a mobile user interface device. The data may be static and/or dynamic data for the other event sites. This may be accomplished, for example, by using Microsoft™ Passport techniques.

In certain implementations, accessing an event wireless network may be accomplished by registering for the event before hand. The registration may be accomplished by any appropriate technique for contacting the event provider, such as, for example, by telephone or Internet. Registering may, for example, allow a user and/or interface device to acquire an identifier and/or password for accessing the event wireless network when at the event. The identifier may be sent automatically by the mobile user interface device, entered by a user in a sign-on screen, possibly in response to a challenge from the wireless network, or otherwise.

In some implementations, the service level provided to a mobile user interface device may be upgraded during a wireless network session. This may be accomplished by the user requesting enhanced services and possibly providing financial information, such as, for example a credit card number. In certain implementations, a user may have a pre-stored user financial profile with the event wireless network provider.

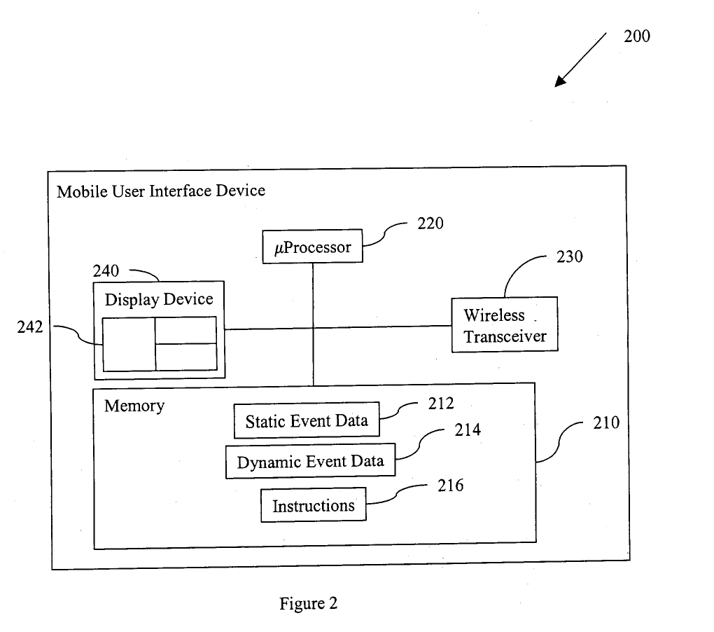

FIG. 2 illustrates a mobile user interface device 200 that is operable to receive data from a wireless network and present the data to a user. Mobile user interface device 200 may be utilized in a system such as the system illustrated in FIG. 1.

In more detail, mobile user interface device 200 includes memory 210, a microprocessor 220, a wireless transceiver 230, and a display device 240. Memory 210 may be RAM, ROM, CD-ROM, a flash card, registers, and/or any other type of volatile or non-volatile information storage apparatus. Memory 210 contains static event data 212, dynamic event data 214, and instructions 216, which dictate the higher-level operations of the interface device. Memory 210 may also contain a variety of other information. Microprocessor 220 is responsible for executing instructions 216 to perform the higher-level operations of mobile user interface device 200. Microprocessor 220 may be a reduced instruction set computer (RISC), a complex instruction set computer (CISC), or any other appropriate digital device for manipulating information in a logical manner. Wireless transceiver 230 is responsible for sending information to and receiving information from a wireless network. Wireless transceiver 240 may be an RF or IR transceiver, or any other appropriate device for exchanging information by the use of wireless electromagnetic signals. Display device 240 is responsible for displaying a user interface 242. Display device 240 may be a CRT display, an LCD, a projector, or any other appropriate device for displaying information.

In one mode of operation, microprocessor 220 waits to detect reception of static data for an event. The data may include, for example, biographies, career statistics, and/or any other type of information about event participants. Receiving the data may be accomplished, for example, by receiving media, such as, for example, a CD-ROM or a smart card, containing the data. The static data may be received before or after the user arrives at the associated event.

After receiving the static event data, the microprocessor 220 generates the user interface 242 to present at least some of the static event data. In particular implementations, user interface 242 is an interactive, graphics-based user interface. The user interface may be generated automatically, in response to a signal indicating an appropriate user command, or otherwise. The user interface may then be displayed to a user using display device 240.

Microprocessor 220 also may detect a signal indicating a request to alter the user interface. Such a signal is usually generated in response to a user command. If such a signal is detected, the microprocessor updates the user interface. Updating the user interface, which may include generating another user interface, may include replacing a portion of the user interface, replacing several portions of a user interface, replacing all portions of the user interface, replacing part of the information in the user interface, replacing all of the information in the user interface, or otherwise.

Microprocessor 220 also determines whether wireless transceiver 230 detects a wireless network. The wireless network may be a Bluetooth™ network, an IEEE 802.11 network, or any other appropriate type of wireless network. If wireless transceiver 230 detects a wireless network, microprocessor 220 determines whether the wireless network is for the event associated with the static event data. Microprocessor 220 may make this determination by comparing an identifier for the wireless network to an identifier with the static event data, for example. If the wireless network is for the event, the interface device establishes a wireless network session. Establishing a wireless network session may entail registering the mobile user interface device, validating the mobile user interface device, negotiating channels, negotiating access times, determining service levels for the mobile user interface device, and/or any other appropriate functions for establishing a wireless network session.

Once the wireless network session is established, microprocessor 220 determines whether dynamic data for the event has been received. Dynamic event data, for example, may be current statistics, status, or any other appropriate information regarding event participants. The data may be sent automatically by the wireless network, perhaps using push techniques, requested automatically by the mobile user interface device, or otherwise. After receiving dynamic event data, microprocessor 220 determines whether the data is to be displayed. Determining whether the data is to be displayed may be accomplished, for example, by determining whether the mobile user interface device currently needs to display the data. If the data is to be displayed, microprocessor 220 updates the user interface, which may include generating a user interface. But if the data is not to be displayed, microprocessor 220 determines whether the data is not desired. Data may not be desired, for example, if the data is pushed to a mobile user interface device that has been instructed that a user does not want a certain type of data, if higher priority data is already occupying a large portion of a mobile user interface device's memory, or otherwise. If the data is not desired, the interface device discards the data.

Microprocessor 220 also determines whether a signal indicating a request for dynamic event data has been detected. Such a signal is typically generated in response to a user command. A particularly useful application for this may be a request for a replay of an incident that just occurred. After detecting such a signal, the user interface device generates a wireless network message requesting the data. The message may then be sent to the wireless network. After receiving the data, the interface device determines whether the data is to be displayed by, for example, determining whether the mobile user interface device currently needs to display the data. If the data is to be displayed, the interface device updates the user interface.

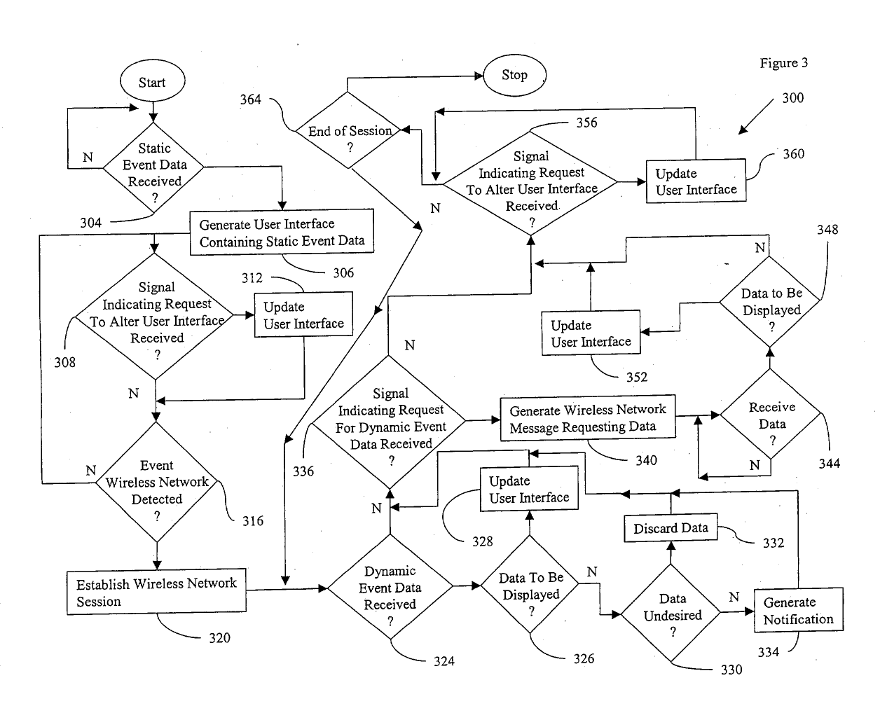

FIG. 3 is a flowchart illustrating a method 300 for providing static and dynamic event data. Method 300 illustrates the operations of a mobile user interface device similar to the mobile user interface device in FIG. 1.

The method begins with the device determining whether static data for an event has been received (step 304). The data may include, for example, biographies, career statistics, and/or any other type of information about event participants. Receiving the data may be accomplished by receiving media, such as, for example, a CD-ROM or a smart card, containing the data, receiving the data through a download over a communication network, or otherwise. The static data may be received before or after the user arrives at the associated event.

After receiving the static data, the device generates a user interface containing at least some of the static event data (step 306). The user interface may be a text-based user interface, a graphics-based user interface, or an interface having any other format for presenting information to a user. The user interface may be generated automatically, in response to a signal indicating an appropriate user command, or otherwise. The user interface then may be displayed to a user to present the static event data.

The method continues with the device determining whether a signal indicating a request to alter the user interface has been detected (step 308). Such a signal is usually generated in response to a user command. If such a signal has been detected, the user interface is updated (step 312). Updating the user interface, which may include generating a user interface, may include, for example, replacing a portion of the user interface, replacing several portions of the user interface, replacing all portions of the user interface, replacing part of the information in the user interface, or replacing all of the information in the user interface.

The device then determines whether a wireless network for the event has been detected (step 316). The wireless network may be a Bluetooth™ network, an IEEE 802.11 network, or any other appropriate type of wireless network. The wireless network may be detected by receiving a wireless signal containing a recognized identifier for the wireless network for the event. If no wireless network for the event is detected, another determination is made as to whether a signal indicating a request to alter the user interface has been detected (step 308).

If, however, the device detects a wireless network for the event, the device establishes a wireless network session (step 320). Establishing a wireless network session may include registering a mobile user interface device, validating the mobile user interface device, negotiating channels, negotiating access times, determining levels of service, and/or any other appropriate functions for establishing a wireless network session. Registering the mobile user interface device many include generating a wireless message containing a predefined event identifier. The predefined event identifier may identify the mobile user interface device, a user of the mobile user interface device, or other entity to an event wireless network. The predefined event identifier may be established with an event wireless network before or after arriving at the event.

The device then determines whether dynamic data for the event has been received (step 324). Dynamic event data may be current statistics, status, or any other appropriate information regarding event participants. The data may be sent automatically by the wireless network, perhaps using push techniques, requested automatically by a mobile user interface device, requested in response to a user command, or otherwise. The data may be conveyed in any appropriate type of wireless message format.

If dynamic event data has been received, the device determines whether the data is to be displayed (step 326). Determining whether the data is to be displayed may be accomplished, for example, by determining whether a mobile user interface device currently needs to display the data. If the data is to be displayed, the device updates the user interface (step 328). Updating the user interface, which may include generating a user interface, may include replacing all or part of the user interface.

If, however, the data is not to be displayed, the device determines whether the data is undesired (step 330). Data may not be desired, for example, if it is pushed to a mobile user interface device that has been instructed that a user does not want a certain type of data, if higher priority data is already occupying a large portion of a mobile user interface device's memory, or otherwise. If the data is undesired, the device discards the data (step 332). If the data is not undesired, the device generates a notification that the data has been received (step 334). The notification may then be conveyed to a user—visually, audibly, or otherwise.

The device then determines whether a signal indicating a request for dynamic event data has been received (step 336). Such a signal is typically generated in response to a user command. A particularly useful application for this may be a request for a replay of an event incident that just occurred. If such a signal has been detected, the device generates a wireless network message requesting the data (step 340) and waits to receive the data (step 344). After receiving the data, the device determines whether the data is to be displayed (step 348). The device may determine whether the data is to be displayed, for example, by determining whether the mobile user interface device currently needs to display the data. If the data is to be displayed, the device updates the user interface (step 352).

The device determines whether a signal indicating a request to alter the user interface has been detected (step 356). Such a request is typically generated in response to a user command. If such a request has been received, the device updates the user interface (step 360). Updating the user interface may include displaying previously received, but undisplayed dynamic event data.

The device then determines whether the wireless session is at an end (step 364). The device may determine whether the session is at an end, for example, by detecting a wireless network message indicating that the session has ended, by determining that a timeout has occurred, or otherwise. If the session is at an end, the method ends. If the session is not at an end, the device checks for additional dynamic event data (step 324).

Although FIG. 3 illustrates one implementation of a method for providing static and dynamic event data, other implementations may include fewer, more, and/or a different arrangement of operations. For example, static event data may not be displayed until detection of the event wireless network or a user command to display the data. As another example, the mobile user interface device may not wait for requested dynamic event data, allowing other functions may be carried out until the data arrives. As a further example, the static and/or dynamic event data may continue to be displayed after the wireless network session has ended. As an additional example, the static event data may be received from the event wireless network. Thus, steps 304-312 may occur after function step 320. Furthermore, static event data may be sent to the mobile user interface device while sending dynamic event data. Moreover, the user interface may be generated with dynamic event data and/or static event data, and dynamic event data may be used to update and/or replace static data. As an additional example, a notification may does not necessarily need to be generated when dynamic data is received. As a further example, a wireless network message specifying a type of dynamic event data to be sent to the mobile user interface device may be generated.

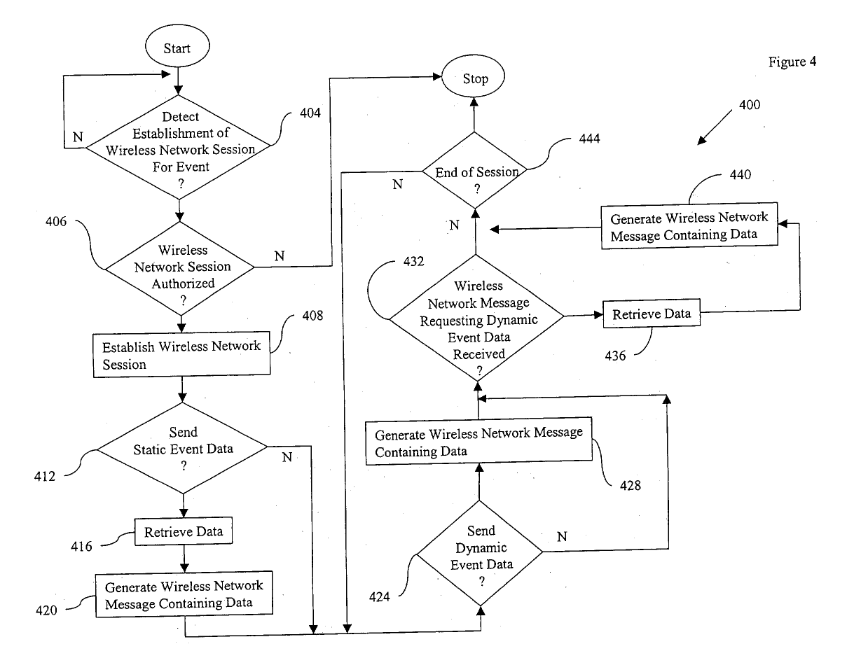

FIG. 4 illustrates a method 400 for providing static and dynamic event data. Method 400 may illustrate the operations for a wireless network similar to the wireless network in FIG. 1.

Initially, the network waits to detect establishment of a wireless network session for an event (step 404). Detecting whether a wireless network session for an event being established may include, for example, detecting a wireless message indicating that a wireless network session is desired.

The network then determines whether the wireless network session is authorized (step 406). Determining whether the wireless network session is authorized may, for example, be accomplished by examining an identifier in a wireless network message. The identifier may be associated with a mobile user interface device, a user of a mobile user interface device, or otherwise. The identifier may be received in response to a challenge by the wireless network and may be encrypted for additional network security. The identifier may be defined by the wireless network before detecting the establishment of the wireless network session for the event.

If the wireless network session is not authorized, the method is at an end. If, however, the wireless network session is authorized, the network establishes a wireless network session (step 408). Establishing a wireless network session may include registering a mobile user interface device, negotiating channels, negotiating access times, determining the level of service required for the session, and/or any other appropriate functions for establishing a wireless network session. The wireless network session may be a Bluetooth™ session, an IEEE 802.11 session, or any other appropriate type of wireless network session.

The network then determines whether static event data should be sent (step 412). Static event data may be, for example, career statistics, biographies, or any other appropriate information regarding event participant. The network may determine whether static event data should be sent may be accomplished by receiving a wireless network message requesting static event data, receiving a signal indicating that a mobile user interface device does not have static event data, determining that a mobile user interface device has not previously accessed the wireless network for the associated event, or otherwise. If static event data is to be sent, the network retrieves static event data (step 416) and generates a wireless network message containing the data (step 420). The message may then be sent to a mobile user interface device. The static event data could come from the event provider, the event participants themselves, a conference or league in which the event participants are members, the event site operator, or otherwise.

The network then determines whether dynamic event data should be sent (step 424). Dynamic event data may be, for example, event statistics and status for an event participant. The network may determine whether dynamic data should be sent, for example, by determining whether there is dynamic data available and whether a mobile user interface device desires the data. If dynamic event data should be sent, the network generates a wireless network message containing the data (step 428). The message may then be sent to a mobile user interface device.

The network then determines whether a wireless network message requesting dynamic event data has been received (step 432). If a message requesting dynamic event data has been received, the network retrieves the requested data (step 436) and generates a wireless network message containing the data (step 440). Retrieving the requested data may include, for example, accessing a database of statistics related to the event, which are typically kept by official scorers for sporting events, or a database containing video clips of the event, which are often produced by a TV network televising the event. The message may then be sent to the mobile user interface device.

The network then determines whether the wireless network session is at an end at (step 444). The network may determine whether the session is at an end, for example, by detecting a wireless network message indicating that the session has ended, by determining that a timeout has occurred, or otherwise. If the session is at an end, the method ends. If the session is not at an end, the network again determines whether to send dynamic event data (step 424).

Although FIG. 4 illustrates one implementation of a method for providing static and dynamic event data, other implementations may include fewer, more, and/or a different arrangement of operations. For example, static event data may not be sent to a mobile user interface device by a wireless network. Moreover, there may be no static event data for a wireless network to send. Thus, steps 412-420 may be eliminated. As another example, dynamic data may not be sent to a mobile user interface device unless requested, and steps 424-428 may be eliminated. As a further example, data about other events may be received and a wireless message to carry this data to a mobile user interface device may be generated and sent. As an additional example, a wireless network message specifying types of dynamic data to be sent may be received and acted upon. As another example, static event data may be requested and received from the wireless network.

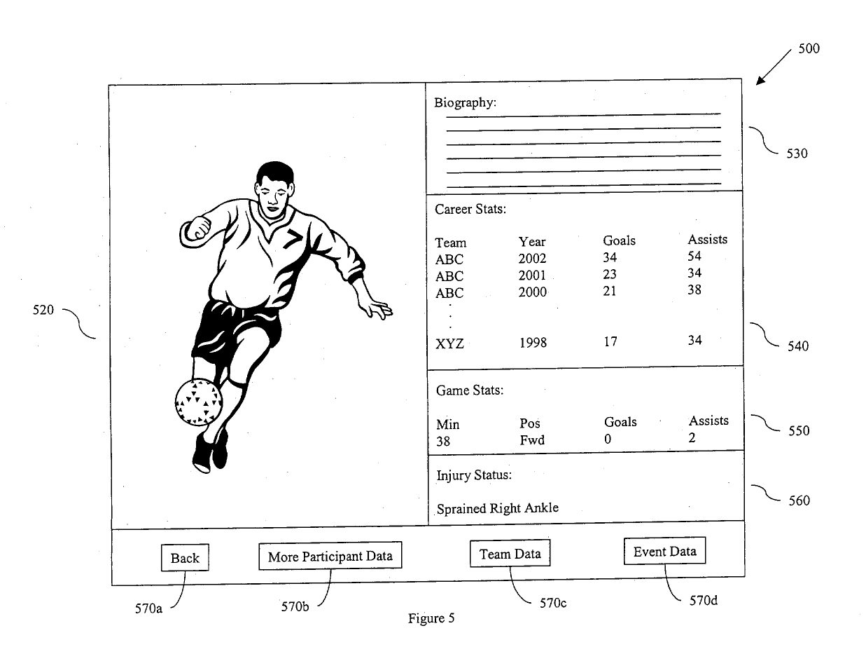

FIG. 5 illustrates a user interface 500 that presents static and dynamic event data for a user of a mobile user interface device. As illustrated, user interface 500 presents static and dynamic event data regarding an event participant.

In more detail, user interface 500 includes a portion 520, a portion 530, a portion 540, a potion 550, and a portion 560. Portion 520 includes a picture of a participant in an event that the spectator is attending. The picture may be taken before or during the event and, hence, may be static or dynamic event data. Portion 530 presents static event data in the form of background textual information about the participant. Portion 540 presents career statistics for the participant, and portion 550 presents current event statistics for the participant. Thus, portion 540 presents static event data, and portion 550 presents dynamic event data. Portion 560 presents status information regarding the participant and, accordingly, may contain static and/or dynamic event data. Note that dynamic event data may be updated as the event progresses.

At the bottom of user interface 500 are several buttons 570 that may be activated to obtain different data. Button 570a allows a user to indicate that he wishes to return to the previous screen presented by the user interface. Button 570b allows a user to request more data regarding the currently-displayed participant. Button 570c allows a user to request data regarding the participant's team. Button 570d allows a user to request data regarding the event itself. Activation of any of buttons 570 may lead to the replacement of one or more portions 520-560, the replacement of information in one or more of the portions, or other results.

Although user interface 500 illustrates one implementation of a user interface presenting static and dynamic event data, other implementations may contain, less, more, and/or a different arrangement of information. For example, the picture in portion 520 may be replaced by a video clip of the participant. In addition, any of portions 520-560 may be deleted, and any assortment of buttons may be used. As a further example, each of portions 520-560 may have buttons so that actions associated therewith may be undertaken.

A number of implementations have been described. It should be understood, however, that other implementations are within the scope of the following claims.

What is claimed is:

1. A method for providing static and dynamic event data, the method comprising:
determining, at a mobile user interface device, whether static event data has been received;
determining, at the mobile user interface device, whether an event wireless network has been detected;
establishing, at the mobile user interface device, a wireless network session if an event wireless network has been detected;
determining, at the mobile user interface device, whether dynamic event data has been received in a wireless network message; and
generating, at the mobile user interface device, a user interface to present at least some of the static event data and at least some of the dynamic event data if static event data and dynamic event data have been received.

2. The method of claim 1, further comprising generating, at the mobile user interface device, a user interface to present at least some of the static event data if static event data has been received.

3. The method of claim 1, further comprising:
determining, at the mobile user interface device, whether dynamic event data has been received in a wireless network message;
determining, if dynamic event data has been received, whether the user interface should be updated with the dynamic event data; and
updating the user interface with the dynamic event data if the user interface should be updated with the dynamic event data.

4. The method of claim 1, wherein static event data comprises pre-event statistics regarding an event participant.

5. The method of claim 1, wherein the user interface comprises a graphical user interface.

6. The method of claim 1, wherein dynamic event data comprises event statistics regarding an event participant.

7. The method of claim 1, further comprising:
determining, at the mobile user interface device, whether a signal indicating a request to alter the user interface has been received; and
updating the user interface if such a signal has been received.

8. The method of claim 1, further comprising:
determining, at the mobile user interface device, whether a signal indicating a request for dynamic event data has been received; and
generating a wireless network message requesting dynamic event data if such a message has been received.

9. The method of claim 1, wherein establishing a wireless network session comprises generating a wireless network message to register the mobile user interface device with a predefined event identifier.

10. A system for providing static and dynamic event data, the system comprising:
a mobile user interface device operable to:
determine whether static event data has been received,
determine whether an event wireless network has been detected,
establish a wireless network session if an event wireless network has been detected,
determine whether dynamic event data has been received in a wireless network message, and
generate a user interface to present at least some of the static event data and at least some of the dynamic event data if static event data and dynamic event data have been received.

11. The system of claim 10, wherein the interface device is further operable to:
determine whether dynamic event data has been received in a wireless network message;
determine, if dynamic event data has been received, whether the user interface should be updated with the dynamic event data; and
update the user interface with the dynamic event data if the user interface should be updated with the dynamic event data.

12. The system of claim 10, wherein the interface device is further operable to:
determine whether a signal indicating a request to alter the user interface has been received; and
update the user interface if such a signal has been received.

13. The system of claim 10, wherein the interface device is further operable to:
determine whether a signal indicating a request for dynamic event data has been received; and
generate a wireless network message requesting dynamic event data if such a message has been received.

14. A set of instructions encoded in a computer-readable medium, the instructions operable to provide static and dynamic event data by:
determining, at a mobile user interface device, whether static event data has been received;
determining, at the mobile user interface device, whether an event wireless network has been detected;
establishing, at the mobile user interface device, a wireless network session if an event wireless network has been detected;
determining, at the mobile user interface device, whether dynamic event data has been received in a wireless network message; and
generating, at the mobile user interface device, a user interface to present at least some of the static event data and at least some of the dynamic event data if static event data and dynamic event data have been received.

15. The instructions of claim 14, wherein the instructions are further operable to provide static and dynamic event data by:
determining, at the mobile user interface device, whether dynamic event data has been received in a wireless network message;
determining, if dynamic event data has been received, whether the user interface should be updated with the dynamic event data; and
updating the user interface with the dynamic event data if the user interface should be updated with the dynamic event data.

16. The instructions of claim 14, wherein the instructions are further operable to provide static and dynamic event data by:
determining, at the mobile user interface device, whether a signal indicating a request to alter the user interface has been received; and
updating the user interface if such a signal has been received.

17. The instructions of claim 14, wherein the instructions are further operable to provide static and dynamic event data by:
determining, at the mobile user interface device, whether a signal indicating a request for dynamic event data has been received; and
generating a wireless network message requesting dynamic event data if such a message has been received.

18. A method for providing static and dynamic event data, the method comprising:
detecting, at a wireless network, establishment of a wireless network session for an event;
determining whether dynamic event data should be sent to a mobile user interface device if initiation of a wireless network session for an event is detected; and
generating a wireless network message containing dynamic event data if dynamic event data should be sent to a mobile user interface device.

19. The method of claim 18, further comprising:
determining whether a wireless network message requesting dynamic event data has been received from a mobile user interface device; and
generating a wireless network message containing dynamic event data if a wireless network message requesting dynamic event data has been received from a mobile user interface device.

20. The method of claim 18, further comprising:
determining whether static event data should be sent to a mobile user interface device; and
generating a wireless network message containing static event data if static event data should be sent to a mobile user interface device.

21. The method of claim 18, further comprising:
determining whether the wireless network session is authorized; and
determining the level of service required for the session.

22. A system for providing static and dynamic event data, the system comprising:
a wireless network operable to:
detect establishment of a wireless network session for an event,
determine whether dynamic event data should be sent to a mobile user interface device if initiation of a wireless network session for an event is detected, and
generate a wireless network message containing dynamic event data if dynamic event data should be sent to a mobile user interface device.

23. The system of claim 22, wherein the wireless network is further operable to:
determine whether a wireless network message requesting dynamic event data has been received from a mobile user interface device; and
generate a wireless network message containing dynamic event data if a wireless network message requesting dynamic event data has been received from a mobile user interface device.

24. The system of claim 22, wherein the wireless network is further operable to:
determine whether static event data should be sent to a mobile user interface device; and
generate a wireless network message containing static event data if static event data should be sent to a mobile user interface device.

25. The system of claim 22, wherein the wireless network is further operable to:
determine whether the wireless network session is authorized; and
determine the level of service required by the session.

26. A system for providing static and dynamic event data, the system comprising:
a mobile user interface device operable to:
determine whether static event data has been received,
generate a graphical user interface to present at least some of the static event data if static event data has been received,
determine whether an event wireless network has been detected,
establish a wireless network session if an event wireless network has been detected,
determine whether dynamic event data has been received in a wireless network message,
determine, if dynamic event data has been received, whether the user interface should be updated with the dynamic event data,
update the user interface with the dynamic event data if the user interface should be updated with the dynamic event data,
determine whether a signal indicating a request to alter the user interface has been received,
update the user interface if such a signal has been received, determine whether a signal indicating a request for dynamic event data has been received, and
generate a wireless network message requesting dynamic event data if such a message has been received; and
a wireless network operable to:
detect establishment of the wireless network session,
determine whether the wireless network session is authorized,
establish the wireless network session with the mobile user interface device if the wireless network session is authorized,
determine whether dynamic event data should be sent to the mobile user interface device if the wireless network session is established,
generate a wireless network message containing dynamic event data if dynamic event data should be sent to the mobile user interface device,
determine whether the wireless network message requesting dynamic event data has been received from the mobile user interface device, and
generate a wireless network message containing dynamic event data if the wireless network message requesting dynamic event data has been received from the mobile user interface device.
